(19) United States
(12) Patent Application Publication
(10) Pub. No.: US 2003/0019465 A1
(43) Pub. Date: Jan. 30, 2003

(54) Fuel injection valve

(76) Inventor: Joerg Heyse, Besigheim (DE)

Correspondence Address: KENYON & KENYON, ONE BROADWAY, NEW YORK, NY, 10004, US

(21) Appl. No.: 10/089,913

(22) PCT Filed: Jul. 19, 2001
(86) PCT No.: PCT/DE01/02709

(30) Foreign Application Priority Data
Aug. 4, 2000 (DE) 10038097.2

(51) Int. Cl. F02B 3/00

(52) U.S. Cl. 123/294

(57) ABSTRACT

The present invention relates to a fuel injector, in particular a fuel injector protruding directly into a combustion chamber of an internal combustion engine, having an energizable actuator (10, 11, 12), a valve-closure member (7) able to be moved by the actuator (10, 11, 12), a secure valve seat (22), with which the valve-closure member (7) cooperates to open and close the valve, a fuel outlet formed in a downstream spray-discharge region and by at least one outlet opening (23) situated downstream from valve seat (22), and a dead volume (25) formed downstream from valve seat (22) and upstream from the spray-discharge region having at least one outlet opening (23). A device for accumulating combustion chamber gas is provided in the valve-closure member (7) in the form of a blind hole (33) having direct access to the dead volume (25).

### BACKGROUND INFORMATION

The present invention is based on a fuel injector of the type set forth in the main claim.

During operation of an engine, the problem generally occurs in the case of direct injection of a fuel into the combustion chamber of an internal combustion engine, particularly in the case of direct gasoline injection or the injection of diesel fuel, that the downstream tip of the injection valve projecting into the combustion chamber is coked by fuel deposits or that soot particles formed in the flame front are deposited on the valve tip. Therefore, in the case of injection valves projecting into the combustion chamber known heretofore, there is the danger during its lifetime of a negative influence on the spray parameter (e.g. static flow quantity, spray angle, drop size, skeining) that can lead to operational disturbances of the internal combustion engine or to a malfunction of the injection valve.

### SUMMARY OF THE INVENTION

The injector valve of the present invention having the characterizing features of the main claim has the advantage that these previously mentioned negative effects of coking (soot depositing) especially on the valve tip projecting into the combustion chamber including its outlet openings is restricted or eliminated. Forming a device for accumulating combustion-chamber gas with access to the dead volume situated between valve needle end and the spray region including the outlet openings in accordance with the present invention makes it possible to largely prevent coke deposits in the outlet openings. The buoyancy of the gas phase with respect to the liquid phase causes the gas to remain in the device for accumulating combustion chamber gas.

In this manner, the spray parameter and the valve function are able to be maintained in a stable manner during its entire lifetime even in the case of direct injection of fuel into a combustion chamber at the fuel injection valves.

The measures specified in the subclaims permit advantageous further developments and improvements of the fuel injector indicated in the main claim.

It is advantageous to provide one or more blind holes on the valve needle end facing the outlet openings, i.e., on the surface of the valve-closure member facing the dead volume. In this context, it must be ensured that the blind holes have access to the dead volume and that the gas volume is not able to escape from the gas accumulation volume by buoyancy force.

### BRIEF DESCRIPTION OF THE DRAWING

An exemplary embodiment of the present invention is represented in simplified form in the drawing, and is explained in detail in the following description.

FIG. 1 shows part of a fuel injector, and

FIG. 2 shows a schematic section of an outlet opening having a breaking-off liquid column situated therein.

### DESCRIPTION OF THE EXEMPLARY EMBODIMENTS

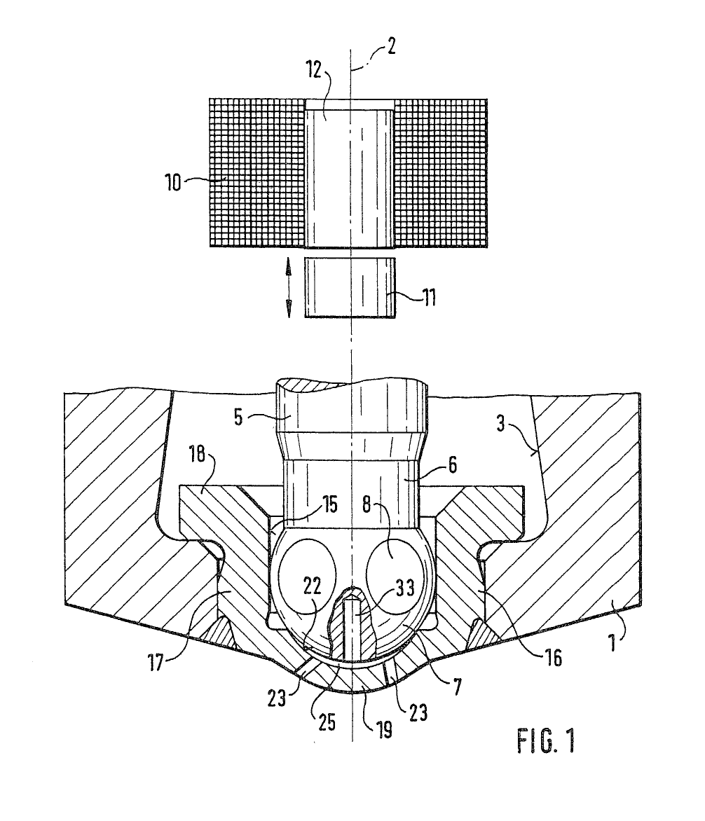

FIG. 1 partially shows a valve in the form of an injection valve for fuel injection systems of mixture-compressing, externally ignited internal combustion engines as an exemplary embodiment. The injection valve has a tubular valve-seat support 1, in which a longitudinal opening 3 is formed concentrically to a longitudinal valve axis 2. Situated in longitudinal opening 3 is a, for example, tubular valve needle 5, which is securely connected at its downstream end 6 to a, for example, spherical valve closure member 7, on whose periphery, for example, five flattenings 8 are provided for the fuel to flow past.

The fuel injector is actuated in a known manner, e.g. electromagnetically. A schematically indicated electromagnetic circuit having magnetic coil 10, an armature 11, and an core 12 is used for axially moving valve needle 5, and as such, for opening the fuel injector against the spring force of a restoring spring (not shown) and for closing the fuel injector. Armature 11 is connected, for example, by a welded seam formed by a laser to the end of valve needle 5 away from valve-closure member 7, and is aligned with core 12.

A guide opening 15 of a valve-seat member 16, which is sealingly mounted by welding in the downstream end of valve-seat support 1 away from core 12, in longitudinal opening 3, which runs concentrically to longitudinal valve axis 2, is used for guiding valve-closure member 7 during the axial movement. Valve-seat member 16 has a cupped design, for example, a jacket part 17 of valve-seat member 16 transitioning in the direction of armature 11 into a collar 18 abutting against valve-seat support 1. On the side opposite collar 18, valve-seat member 16 has a base part 19, which is convexly curved, for example.

The insertion depth of valve-seat member 16 determines the magnitude of the lift of valve needle 5 since the one end position of valve needle 5 in the case of a non-energized magnetic coil 10 is determined by the seating of valve-closure member 7 at valve-seat surface 22, which tapers conically in a downstream direction or has a slightly curved design, on base part 19 of valve-seat member 16. Given an energized magnetic coil 10, the other end position of valve needle 5 is determined, e.g. by the seating of armature 11 on core 12. Therefore, the path between these two end positions of valve needle 5 represents the lift. Spherical valve-closure member 7 cooperates with truncated-cone-shaped or curved valve-seat surface 22 of valve-seat member 16, which is formed between guide opening 15 and a plurality of outlet openings 23 inserted in a central region of base part 19 of valve-seat member 16. Base part 19 forms the spray-discharge region of the fuel injector.

In particular, the fuel injector is designed as a so-called multi-hole valve that is particularly suited for injecting fuel directly into a combustion chamber (not shown). In this context, at least 2 or also four or significantly more outlet openings 23 are inserted in base part 19 of valve-seat member 16, e.g. via erosive machining, laser drilling, or punching. For a desired filling of the combustion chamber with fuel, outlet openings 23 are aligned, for example, at different angles to longitudinal valve axis 2, all outlet openings 23, for example, moving away from longitudinal valve axis 2 in the downstream direction at an angle.

Especially such multi-hole valves for directly injecting fuel into a combustion chamber whose outlet openings are directly subjected to the combustion chamber atmosphere are extremely susceptible to coking. In an unfavorable case, such outlet openings may have build-up on their periphery due to coke deposits, thereby making it impossible for the desired injection quantities to be dosed and metered in acceptable amounts.

The fuel injector of the present invention is to largely prevent coke deposits of the combustion chamber in the region of outlet openings 23 from obstructing the outlet openings and significantly changing the injection quantities during the valve's lifetime.

Since valve-closure member 7 and curved base part 19 of valve-seat member 16 are formed with different radii, there is, when the injector valve is closed, an enclosed space representing a dead volume 25 within annular valve-seat surface 22 in the region of outlet openings 23, between valve-closure member 7 and base part 19. In accordance with the present invention, gas is to be accumulated in dead volume 25 in order to prevent coke deposits at outlet openings 23. Before this functional principle of gas accumulation is described, the creation of coke deposits is to be briefly explained in the following.

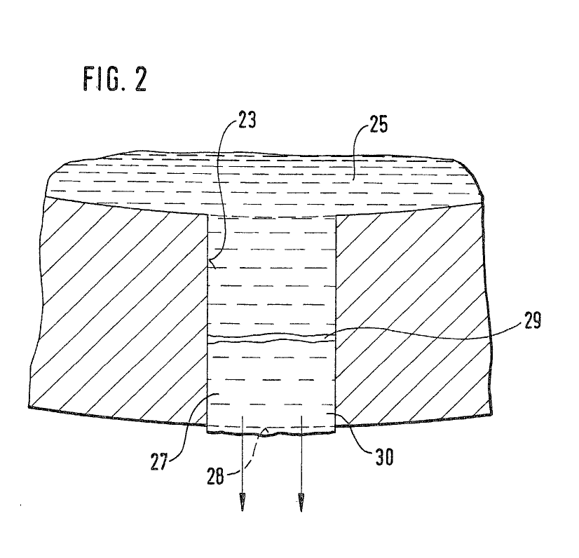

The processes of through-flow and coking are subsequently explained on the basis of FIG. 2, which schematically shows an outlet opening 23. When valve-closure member 7 is pressed back at the end of the injection operation onto valve-seat surface 22, the flow through outlet openings 23 is stopped abruptly. Therefore, no more fuel continues to flow through the sealing seat region past valve-seat surface 22 into dead volume 25.

Due to its weight, liquid column 27, which is emerging from outlet openings 23 immediately prior to the closing of the valve, possesses a certain inertia. The low pressure in liquid column 27 produced as a result of the closing of the valve and of the associated stop of the flow in the sealing seat region becomes greater as a function of inertia starting from an outlet plane 28 of outlet opening 23 in the downstream direction within outlet opening 23. At a certain location 29 within liquid column 27, the vapor pressure of the liquid is insufficient. A vapor phase forms suddenly at this location 29, thereby causing part 30 of liquid column 27, which is downstream of this location 29, to break away from the remaining liquid as a result of inertia.

A meniscus of liquid at which there is a phase boundary between the liquid and the gas surrounding the valve forms within outlet opening 23. When injecting fuel directly into a combustion chamber, all components directly on the combustion chamber, therefore also a direct injection valve, in particular outlet openings 23, which project into the combustion chamber, are subjected to an extreme influence of heat. During combustion, coke residues may form on the above-mentioned phase boundary in particular and build-up on the wall of outlet opening 23, thereby resulting in the previously explained disadvantages. Consequently, in the case of known valves, annular coke deposits that disadvantageously constrict flow result at a certain depth in outlet openings 23.

In the design of the fuel injector of the present invention, outlet openings 23 are completely emptied for which reason no coke deposits are able to form within outlet openings 23. In accordance with the present invention, a device for gas accumulation is, therefore, produced directly at dead volume 25. In the exemplary embodiment shown in FIG. 1, this device for gas accumulation is designed as central blind hole 33 in valve-closure member 7 on its surface facing dead volume 25. Blind hole 33 is filled with combustion chamber gas, i.e., with the air dissolved in the fuel. The buoyancy of the gas phase with respect to the liquid phase causes the gas to remain in blind hole 33.

When opening the valve by raising valve-closure member 7 from valve-seat surface 22, the fluid pressure in dead volume 25 increases, thereby compressing the gas volume in blind hole 33. In this context, the gas is pressed further into blind hole 33. When closing the valve, the fluid pressure decreases again, and the gas volume expands again within blind hole 33. Since additional fluid is prevented from flowing into dead volume 25 when the valve is closed, an underpressure is produced in the liquid phase as a result of the inertia of the just emerged fluid. As a result, the gas volume of blind hole 33 is able to expand even further, so that it partially reaches into dead volume 25. The fluid volume expelled in this manner is able to flow out of outlet opening 23.

While a pressure equilibrium returns in dead volume 25, the remaining fluid volume recedes from outlet openings 23 into dead volume 25 as a result of a contraction of the gas phase. Outlet openings 23 fill completely with combustion chamber gas. The liquid column disappears completely from outlet openings 23. In this manner, there is also no more meniscus of liquid column 27 in outlet opening 23 for which reason disadvantageous, annular coking deposits are also not able to form in outlet opening 23.

Instead of an individual blind hole 33, a plurality of smaller blind holes 33 may also be provided next to one another on the valve needle end facing outlet openings 23, i.e., on valve-closure member 7. This has the advantage that given the same gas accumulation volume, the cross section of individual blind holes 33 is smaller and, consequently, the capillary effect in blind holes 33 increases. Therefore, the accumulated gas is even less able to be expelled by flow forces of the liquid.

The valve needle tip, i.e., valve-closure member 7 is not the only component part of the fuel injector on which blind holes of the present invention are able to be formed. Rather, it must be ensured that blind holes 33 have access to dead volume 25 and that the gas volume is not able to escape from the gas accumulation volume by buoyancy force.

What is claimed is:

1. A fuel injector, in particular a fuel injector protruding directly into a combustion chamber of an internal combustion engine, having an energizable actuator (10, 11, 12), a valve-closure member (7) able to be moved by the actuator (10, 11, 12), a secure valve seat (22), with which the valve-closure member (7) cooperates to open and close the valve, a fuel outlet formed in a downstream spray-discharge region and by at least one outlet opening (23) situated downstream from valve seat (22), and a dead volume (25) formed downstream from valve seat (22) and upstream from the spray-discharge region having at least one outlet opening (23), wherein a device (33) for accumulating combustion chamber gas having direct access to the dead volume (25) is provided in at least one component part bordering the dead volume (25).

2. The fuel injector as recited in claim 1, wherein the device (33) for accumulating combustion chamber gas is designed such that the accumulated gas is not able to escape from the gas accumulation volume by buoyancy force.

3. The fuel injector as recited in claim 1 or 2, wherein the device for accumulating combustion chamber gas is formed by a blind hole (33) on one component part bordering dead volume (25).

4. The fuel injector as recited in claim 1 or 2, wherein the device for accumulating combustion chamber gas is formed by a plurality of blind holes (33) on one component part bordering dead volume (25).

5. The fuel injector as recited in claim 3 or 4, wherein the at least one blind hole (33) is provided on a downstream valve needle end facing the outlet openings (23), i.e., on valve-closure member (7) on its surface facing the dead volume (25).

6. The fuel injector as recited in claim 5, wherein the valve-closure member (7) has a spherical design, and the at least one blind hole (33) has a cylindrical form.

7. The fuel injector as recited in claim 6, wherein the at least one blind hole (33) runs along the longitudinal valve axis (2).

8. The fuel injector as recited in one of the preceding claims,
wherein the spray-discharge region having the at least one outlet opening (23) as base part (19) of a valve-seat member (16) having the valve seat (22) is convexly curved.

9. The fuel injector as recited in one of the preceding claims,
wherein the fuel injector protrudes into the combustion chamber of an externally ignited internal combustion engine.

10. The fuel injector as recited in one of claims 1 through 8,
wherein the fuel injector protrudes into the combustion chamber of a self-igniting internal combustion engine.
